(19) United States
(12) Patent Application Publication
(10) Pub. No.: US 2026/0181554 A1
(43) Pub. Date: Jun. 25, 2026

(54) LOWER POWER WAKE-UP SIGNAL OPERATION

(71) Applicant: Nokia Technologies Oy, Espoo (FI)

(72) Inventors: Chunli WU, Beijing (CN); Samuli Heikki TURTINEN, Ii (FI); Jussi-Pekka KOSKINEN, Oulu (FI); Jorma Johannes KAIKKONEN, Oulu (FI)

(21) Appl. No.: 19/125,785

(22) PCT Filed: Nov. 7, 2022
(86) PCT No.: PCT/CN2022/130438

§ 371 Date: Apr. 30, 2025

(51) Int. Cl. H04W 52/02; H04W 72/23

(52) U.S. Cl. CPC H04W 52/0235; H04W 72/23

(57) ABSTRACT

Exemplary embodiments of the present disclosure relate to lower power wake-up signal operation. In an example apparatus, an apparatus obtains, from a network device, information related to the apparatus monitoring a physical downlink control channel (PDCCH) from the network device, and switches, based on the information, from monitoring the PDCCH to monitoring a low power wake-up signal (LP-WUS) from the network device. In this way, the terminal device can be switched from monitoring PDCCH to monitoring LP-WUS.

### FIELD

Exemplary embodiments of the present disclosure generally relate to the field of telecommunication, and in particular, to apparatuses, methods and a computer-readable storage medium for lower power wake-up signal operation.

### BACKGROUND

5G systems are designed and developed targeting for both mobile telephony and vertical use cases. Besides latency, reliability, and availability, UE energy efficiency is also critical to 5G. Currently, 5G devices may have to be recharged per week or day, depending on individual's usage time. In general, 5G devices consume tens of milliwatts in RRC idle/inactive state and hundreds of milliwatts in RRC connected state. Design to prolong battery life is a necessity for improving energy efficiency as well as for better user experience.

### SUMMARY

In general, exemplary embodiments of the present disclosure provide a solution for lower power wake-up signal operation.

In a first aspect, there is provided an apparatus. The apparatus comprises: at least one processor; and at least one memory storing instructions that, when executed by the at least one processor, cause the apparatus at least to: obtain, from a network device, information related to the apparatus monitoring a physical downlink control channel (PDCCH) from the network device; and switch, based on the information, from monitoring the PDCCH to monitoring a low power wake-up signal (LP-WUS) from the network device.

In a second aspect, there is provided an apparatus. The apparatus comprises: at least one processor; and at least one memory storing instructions that, when executed by the at least one processor, cause the apparatus at least to: determine information related to a terminal device switching from monitoring a physical downlink control channel (PDCCH) from the apparatus to monitoring a low power wake-up signal (LP-WUS) from the apparatus; and transmit the information to the terminal device.

In a third aspect, there is provided a method performed by a terminal device. The method comprises: obtaining, from a network device, information related to the apparatus monitoring a physical downlink control channel (PDCCH) from the network device; and switching, based on the information, from monitoring the PDCCH to monitoring a low power wake-up signal (LP-WUS) from the network device.

In a fourth aspect, there is provided a method performed by a network device. The method comprises: determining information related to a terminal device switching from monitoring a physical downlink control channel (PDCCH) from the apparatus to monitoring a low power wake-up signal (LP-WUS) from the apparatus; and transmitting the information to the terminal device.

In a fifth aspect, there is provided an apparatus. The apparatus comprises: means for obtaining, from a network device, information related to the apparatus monitoring a physical downlink control channel (PDCCH) from the network device; and means for switching, based on the information, from monitoring the PDCCH to monitoring a low power wake-up signal (LP-WUS) from the network device.

In a sixth aspect, there is provided an apparatus. The apparatus comprises: means for determining information related to a terminal device switching from monitoring a physical downlink control channel (PDCCH) from the apparatus to monitoring a low power wake-up signal (LP-WUS) from the apparatus; and means for transmitting the information to the terminal device.

In a seventh aspect, there is provided a non-transitory computer-readable storage medium having instructions stored thereon. The instructions, when executed on at least one processor, cause the least one processor at least to: obtain, from a network device, information related to the apparatus monitoring a physical downlink control channel (PDCCH) from the network device; and switch, based on the information, from monitoring the PDCCH to monitoring a low power wake-up signal (LP-WUS) from the network device.

In an eighth aspect, there is provided a non-transitory computer-readable storage medium having instructions stored thereon. The instructions, when executed on at least one processor, cause the least one processor at least to: determine information related to a terminal device switching from monitoring a physical downlink control channel (PDCCH) from the apparatus to monitoring a low power wake-up signal (LP-WUS) from the apparatus; and transmit the information to the terminal device.

In a ninth aspect, there is provided a computer program comprising instructions, which, when executed by an apparatus, cause the apparatus at least to: obtain, from a network device, information related to the apparatus monitoring a physical downlink control channel (PDCCH) from the network device; and switch, based on the information, from monitoring the PDCCH to monitoring a low power wake-up signal (LP-WUS) from the network device.

In a tenth aspect, there is provided a computer program comprising instructions, which, when executed by an apparatus, cause the apparatus at least to: determine information related to a terminal device switching from monitoring a physical downlink control channel (PDCCH) from the apparatus to monitoring a low power wake-up signal (LP-WUS) from the apparatus; and transmit the information to the terminal device.

In an eleventh aspect, there is provided an apparatus. The apparatus comprises: obtaining circuitry configured to obtain, from a network device, information related to the apparatus monitoring a physical downlink control channel (PDCCH) from the network device; and a switching circuitry configured to switch, based on the information, from monitoring the PDCCH to monitoring a low power wake-up signal (LP-WUS) from the network device.

In a twelfth aspect, there is provided an apparatus. The apparatus comprises: a determining circuitry configured to determine information related to a terminal device switching from monitoring a physical downlink control channel (PDCCH) from the apparatus to monitoring a low power wake-up signal (LP-WUS) from the apparatus; and a transmitting circuitry configured to transmit the information to the terminal device.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some exemplary embodiments will now be described with reference to the accompanying drawings, in which:

FIG. 1A illustrates an example of a network environment in which some exemplary embodiments of the present disclosure may be implemented;

FIG. 1B illustrates a schematic diagram of UE operations with low-power wake-up receiver (WUR) based on which some exemplary embodiments of the present disclosure may be implemented;

FIG. 2 illustrates a flowchart illustrating a communication process in accordance with some exemplary embodiments of the present disclosure;

FIG. 3 illustrates a flowchart of an example method implemented at a terminal device in accordance with some exemplary embodiments of the present disclosure;

FIG. 4 illustrates another flowchart of an example method implemented at a network device in accordance with some exemplary embodiments of the present disclosure; and

FIG. 5 illustrates a simplified block diagram of a device that is suitable for implementing some exemplary embodiments of the present disclosure; and

FIG. 6 illustrates a block diagram of an example of a computer-readable medium in accordance with some exemplary embodiments of the present disclosure.

Throughout the drawings, the same or similar reference numerals represent the same or similar elements.

### DETAILED DESCRIPTION

Principle of the present disclosure will now be described with reference to some exemplary embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of exemplary embodiments. As used herein, the term “and/or” includes any and all combinations of one or more of the listed terms.

The terminology used herein is for the purpose of describing particular embodiments only and is not intended to be limiting of exemplary embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components /d/ or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” (also referred to as “network node”) refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Energy efficiency is even more critical for UE without a continuous energy source, e.g., UE using small rechargeable and single coin cell batteries. The power consumption depends on the configured length of wake-up periods, e.g., paging cycle. To meet the battery life requirements above, eDRX cycle with large value is expected to be used, resulting in high latency, which is not suitable for such services with requirements of both long battery life and low latency.

Currently, a UE architecture is proposed by using a wake-up signal to trigger the main radio and a separate receiver which has the ability to monitor wake-up signal with ultra-low power consumption. Main radio works for data transmission and reception, which may be turned off or set to deep sleep unless it is turned on. Basically, the NW triggers the UE to wake-up exactly when needed in an event-driven manner, by transmitting a special WUS to the UE, which is monitored by the dedicated LP-WUS receiver at the UE. When a UE receives the WUS, the WUS receiver may trigger the wake-up of the ordinary NR transceiver and communication may start. Thus, the ultra-low power receiver wakes up the main radio and otherwise, the main radio is OFF or kept in a deep sleep mode. The assumption is that the low-power wake-up receiver may be operated in an always ‘on’ manner with very low power consumption.

The intention is that the main radio of the UE may be in a sleep mode (or even powered off) for power saving and be activated only upon the reception of the wake-up signal from the network. Basically, the network triggers the UE to wake-up exactly when needed in an event-driven manner, by transmitting a special WUS to the UE, which is monitored by the dedicated low-power WUS receiver at the UE. When a UE receives the WUS, the WUS receiver may trigger the wake-up of the ordinary NR transceiver and communication may start. Thus, the ultra-low power receiver wakes up the main radio and otherwise, the main radio is OFF or kept in a deep sleep mode. The assumption is that the low-power wake-up receiver may be operated in an always ‘on’ manner with very low power consumption. In fact, it is expected that it will consume significantly less power compared to the NR transceiver, by designing a simple (WUS) signal and the use of dedicated hardware for its monitoring, which is only able to receive the WUS.

However, current discussions mainly focused on DL reception where LP-WUS may be used to wake up the main radio to receive PDCCH/PDSCH. It is unclear how the UE switches back to LP-WUS monitoring mode after waking up the main radio to receive PDCCH/PDSCH. It is also unclear yet whether LP-WUS works together with discontinuous reception (DRX) or also works without DRX configuration.

DRX allows the UE to periodically enter the sleep state (sleep mode) at certain times and does not monitor the PDCCH or the PDCCH occasions at these times. When monitoring is required, UE will be waked up from sleep mode, so that the UE may achieve the purpose of power saving. If there is no DRX configured for UE, the UE will always monitor the downlink PDCCH occasions to see if there is scheduling from the serving cell.

If LP-WUS works, there is a need to define how to start the LP-WUS monitoring mode and when the NW may indicate or transmit the LP-WUS to the UE. It should define how the UE switches between LP-WUS monitoring mode and PDCCH monitoring mode.

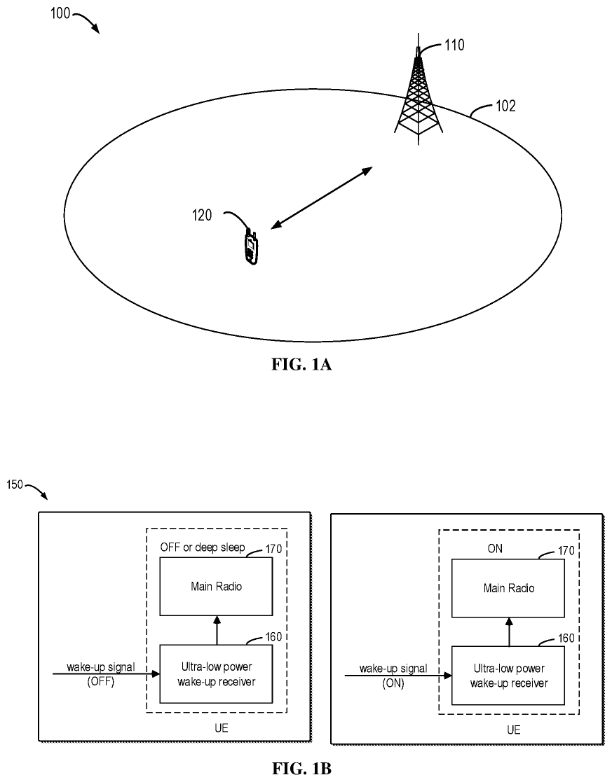

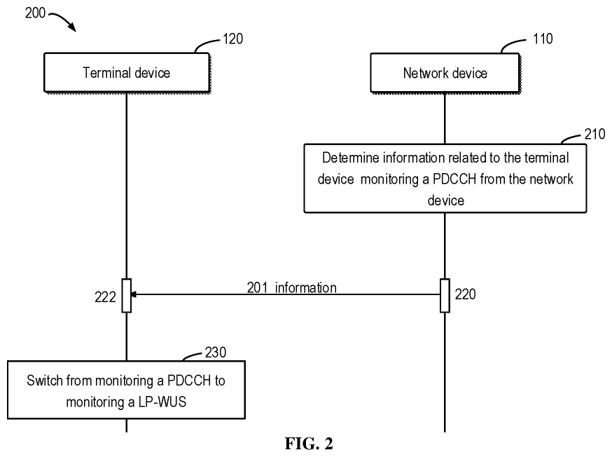

FIG. 1A illustrates an example of a network environment 100 in which some exemplary embodiments of the present disclosure may be implemented. In the descriptions of the exemplary embodiments of the present disclosure, the network environment 100 may also be referred to as a communication system 100 (for example, a portion of a communication network). For illustrative purposes only, various aspects of exemplary embodiments will be described in the context of one or more terminal devices and network devices that communicate with one another. It should be appreciated, however, that the description herein may be applicable to other types of apparatus or other similar apparatuses that are referenced using other terminology.

The network device 110 may provide services to the terminal device 120, and the network device 110 and the terminal device 120 may communicate data and control information with each other. In some exemplary embodiments, the network device 110 and the terminal device 120 may communicate with direct links/channels.

In the communication system 100, a link from the network device 110 to the terminal device 120 is referred to as a downlink (DL), while a link from the terminal device 120 to the network device 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting (TX) device (or a transmitter) and the network device 110 is a RX device (or a receiver). It is to be understood that the network device 110 may provide one or more serving cells. As illustrated in FIG. 1A, the network device 110 provides one serving cell 102, and the terminal device 120 camps on the serving cell 102. In some exemplary embodiments, the network device 110 may provide multiple serving cells. It is to be understood that the number of serving cell(s) shown in FIG. 1A is for illustrative purposes only without suggesting any limitation.

Communications in the network environment 100 may be implemented according to any proper communication protocol(s), comprising, but not limited to, cellular communication protocols of the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the number of devices and their connection relationships and types shown in FIG. 1A are for illustrative purposes only without suggesting any limitation. The communication system 100 may comprise any suitable number of devices adapted for implementing embodiments of the present disclosure.

As described above, 5G systems are designed and developed targeting for both mobile telephony and vertical use cases. Besides latency, reliability, and availability, UE energy efficiency is also critical to 5G. Currently, 5G devices may have to be recharged per week or day, depending on individual's usage time. In general, 5G devices consume tens of milliwatts in RRC idle/inactive state and hundreds of milliwatts in RRC connected state. Designs to prolong battery life are necessary for improving energy efficiency as well as for better user experience.

Energy efficiency is even more critical for UEs without a continuous energy source, e.g., UEs using small rechargeable and single coin cell batteries. Among vertical use cases, sensors and actuators are deployed extensively for monitoring, measuring, charging, etc. Generally, their batteries are not rechargeable and expected to last at least few years as described in 3GPP TR 38.875. Wearables include smart watches, rings, eHealth related devices, and medical monitoring devices. With typical battery capacity, it is challenging to sustain up to 1-2 weeks as required.

The power consumption depends on the configured length of wake-up periods, e.g., paging cycle. To meet the battery life requirements above, extended discontinuous reception (eDRX) cycle with large value is expected to be used, resulting in high latency, which is not suitable for such services with requirements of both long battery life and low latency. For example, in fire detection and extinguishment use case, fire shutters shall be closed and fire sprinklers shall be turned on by the actuators within 1 to 2 seconds from the time the fire is detected by sensors, long eDRX cycle cannot meet the delay requirements. eDRX is apparently not suitable for latency-critical use cases. Thus, the intention is to study ultra-low power mechanism that can support low latency in Rel-18, e.g. lower than eDRX latency.

Currently, UEs need to periodically wake up once per DRX cycle, which dominates the power consumption in periods with no signaling or data traffic. If UEs are able to wake up only when they are triggered, e.g., paging, power consumption could be dramatically reduced. This can be achieved by using a wake-up signal to trigger the main radio and a separate receiver which has the ability to monitor wake-up signal with ultra-low power consumption. Main radio works for data transmission and reception, which can be turned off or set to deep sleep unless it is turned on. This will be described in more detail with reference to FIG. 1B.

FIG. 1B illustrates a schematic diagram of operations of UE 150 with low-power wake-up receiver (WUR) based on which some exemplary embodiments of the present disclosure may be implemented. Such a UE 150 primarily targets low-power WUS/WUR for power-sensitive, small form-factor devices including IoT use cases (such as industrial sensors, controllers) and wearables. Other use cases are not precluded, e.g. XR/smart glasses, smart phones. As illustrated in FIG. 1B, the UE 150 includes a main radio 170 and a separate receiver, i.e., an ultra-low power wake-up receiver 160.

The main radio 170 of the UE 150 can be in a sleep mode (or even powered off) for power saving and be activated only upon the reception of the wake-up signal from the network (e.g., from a network device). Basically, the network triggers the UE 150 to wake-up exactly when needed in an event-driven manner, by transmitting a special WUS to the UE 150, which is monitored by the dedicated low-power WUS receiver 160 at the UE 150. When the UE 150 receives the WUS, the WUS receiver 160 can trigger the wake-up of the ordinary NR transceiver (which is included in the main radio 170) and communication can start. Thus, the ultra-low power wake-up receiver 160 wakes up the main radio 170 and otherwise, the main radio 170 is OFF or kept in a deep sleep mode, as shown in FIG. 1B.

Strictly speaking, the power consumption for monitoring wake-up signal depends on the wake-up signal design and the hardware module of the wake-up receiver used for signal detecting and processing. Whereas, the assumption is that the low-power wake-up receiver 160 can be operated in an always ‘on’ manner with very low power consumption. In fact, it is expected that it will consume significantly less power compared to the NR transceiver, by designing a simple (WUS) signal and the use of dedicated hardware for its monitoring, which is only able to receive the WUS.

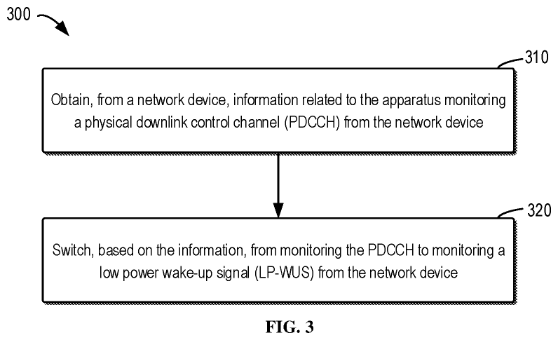

FIG. 2 illustrates a flowchart illustrating a communication process 200 in accordance with some exemplary embodiments of the present disclosure. For the purpose of discussion, the communication process 200 will be described with reference to FIG. 1A. It would be appreciated that although the communication process 200 has been described referring to the network environment 100 of FIG. 1A, this communication process 200 may be likewise applied to other similar communication scenarios.

The network device 110 determines (210) information 201 related to the terminal device 120 switching from monitoring a PDCCH from the network device 110 to monitoring a LP-WUS from the network device 110. The information is about how the terminal device 120 to switch from a PDCCH monitoring mode to a LP-WUS monitoring mode, or about how the terminal device 120 to monitor the PDCCH from the network device 110. The information may be part of the configuration data of the LP-WUS for the terminal device 120.

Although the information is used by the terminal device 120 to switch from monitoring a PDCCH to monitoring a LP-WUS, the information, which is used by terminal device to switch from monitoring a LP-WUS to monitoring a PDCCH, may also be configured in the same way, and the timer described hereinafter will also be applicable to the information related to the switching from monitoring a LP-WUS to monitoring a PDCCH.

As illustrated in FIG. 2, the network device 110 transmits (220) the information 201 to the terminal device 120. Correspondingly, the terminal device 120 obtains or receives (222) the information 201 from the network device 110.

The terminal device 120 switches (230), based on the information 201, from monitoring the PDCCH from the network device 110 to monitoring the LP-WUS from the network device 110. That is to say, based on the information 201, the terminal device 120 switches from the PDCCH monitoring mode to the LP-WUS monitoring mode.

In one option, the information comprises a timer for controlling the switching. During the time period of the timer, the terminal device 120 will monitor the PDCCH from the network device 110, and when the timer expires, the terminal device 120 will switch to the LP-WUS monitoring mode. The timer may be configured by the network device 110 to be part of the configuration information for LP-WUS.

In the following, some example embodiments will be described about how and when the timer will be started. In some exemplary embodiments, the timer is started upon reception of the LP-WUS or transmission of the LP-WUS. That is to say, the inactivity timer is started upon LP-WUS reception at the terminal device 120 or upon LP-WUS transmission at the network device 110. In this way, when the dedicated LP-WUS receiver provided on the terminal device 120 receives the LP-WUS, the timer will be started. Alternatively, when the network device 110 transmits the LP-WUS, the timer will be started.

In some exemplary embodiments, the timer is started upon a first PDCCH occasion when the terminal device 120 starts monitoring the PDCCH. In this situation, the first PDCCH occasion may be not scheduled for this terminal device 120, and this terminal device 120 may receive the first PDCCH after the first PDCCH occasion, for example at the third PDCCH occasion. In this example, regardless of whether the first PDCCH occasion is scheduled for this terminal device 120, the timer is started upon a first PDCCH occasion. In this way, the timer is started after the delay for waking up the main receiver, e.g. started upon the first PDCCH occasion when the terminal device 120 starts monitoring PDCCH. In one example, the timer is started at a first PDCCH occasion after the reception of LP-WUS at the terminal device 120 or after the transmission of LP-WUS at the network device 110. In this example, the first PDCCH occasion after the LP-WUS reception or transmission may or may not be before the delay for waking up the main receiver at the terminal device 120.

In some exemplary embodiments, the timer is started upon first reception of a PDCCH after the terminal device 120 starts monitoring the PDCCH. In this situation, the PDCCH scheduled for this terminal device 120 may not arrive when this terminal device 120 starts monitoring the PDCCH, but after the terminal device 120 starts monitoring the PDCCH. In this example, the timer is started when the terminal device 120 receives the PDCCH for the first time. In this way, the timer is started after the delay for waking up the main receiver, e.g. started upon reception of the first PDCCH.

In some exemplary embodiments, the timer is started when the monitoring of the PDCCH is started, in the event that a plurality of LP-WUS occasions wake up the terminal device 120 to start monitoring the PDCCH in a PDCCH occasion. In this situation, when terminal device may be not always “on” to monitor the LP-WUS from the network device 110 and may periodically monitor the LP-WUS from the network device 110 (i.e. will use a plurality of cycles to monitor the LP-WUS), and thus not only one LP-WUS occasions is used to wake up the main radio of the UE, but a plurality of LP-WUS occasions are used to wake up the main radio of the UE. In this example, it may define that at which one of the plurality of LP-WUS occasions, the main radio or the main receiver of the terminal device 120 is waken up. Upon this LP-WUS occasion for waking up the PDCCH monitoring mode, the timer is started. In this way, more than one WUS occasions wakes up the terminal device 120 to start monitoring PDCCH in the same occasion i.e. many-to-one mapping. In this example, the timer is started when PDCCH monitoring is started. This reduces the risk of timer synchronization issue between the terminal device 120 and the NW 110.

In some exemplary embodiments, the timer is restarted after at least one of a PDCCH reception, a PDSCH reception, or an uplink transmission. For example, after the first PDCCH reception, there may be others PDCCH receptions for this UE. The timer may be restarted after each PDCCH reception, and thus the terminal device 120 may continue to monitor another PDCCH in a new period of the restarted timer. If another PDCCH arrives during the new period of the restarted timer, another PDCCH may be received by the terminal device 120; otherwise, during the period of the restarted timer, there is no other PDCCH and after the timer expires, the terminal device 120 will switch to the LP-WUS monitoring mode to monitor the LP-WUS from the network device 110. For the PDSCH reception and the uplink transmission, the timer may be restarted in the same way.

In another option, the information comprises at least one of an inactivity timer, a round trip time (RTT) timer, and a retransmission timer. That is to say, although DRX is not configured for the terminal device 120 to monitor the PDCCH, the inactivity timer/RTT timer/retransmission timer typically defined for DRX may be reused for monitoring the PDCCH, and the inactivity timer/RTT timer/retransmission timer may be configured to be part of configuration information for the LP-WUS.

In the following, some example embodiments will be described about how and when the inactivity timer, a round trip time (RTT) timer, and a retransmission timer will be started, and how the terminal device works when the timer is started.

In some exemplary embodiments, the inactivity timer is started upon reception of the LP-WUS or transmission of the LP-WUS. That is to say, the inactivity timer is started upon LP-WUS reception at the terminal device 120 or upon LP-WUS transmission at the network device 110. In this way, when the dedicated LP-WUS receiver provided on the terminal device 120 receives the LP-WUS, the inactivity timer will be started. Alternatively, when the network device 110 transmits the LP-WUS, the inactivity timer will be started.

In some exemplary embodiments, the inactivity timer is started upon a first PDCCH occasion when the terminal device 120 starts monitoring the PDCCH. In this situation, the first PDCCH occasion may be not scheduled for this terminal device 120, and this terminal device 120 may receive the first PDCCH after the first PDCCH occasion, for example at the third PDCCH occasion. In this example, regardless of whether the first PDCCH is scheduled for this terminal device 120, the inactivity timer is started upon a first PDCCH occasion. In this way, the inactivity timer is started after the delay for waking up the main receiver, e.g. started upon the first PDCCH occasion when the terminal device 120 starts monitoring PDCCH.

In some exemplary embodiments, the inactivity timer is started upon first reception of a PDCCH after the terminal device 120 starts monitoring the PDCCH. In this situation, the PDCCH scheduled for this terminal device 120 may not arrive when this terminal device 120 starts monitoring the PDCCH, but after the terminal device 120 starts monitoring the PDCCH. In this example, the inactivity timer is started when the terminal device 120 receives the PDCCH for the first time. In this way, the inactivity timer is started after the delay for waking up the main receiver, e.g. started upon reception of the first PDCCH.

In some exemplary embodiments, the RTT timer is started upon transmission of a physical uplink shared channel (PUSCH) or a hybrid automatic repeat request (HARQ) for a downlink transmission. During the period of the RTT timer, the network device 110 may receive and process the data transmitted from the terminal device 120, and the terminal device 120 may not monitor the PDCCH from the network device 110 when the RTT timer is running. In this way, when the terminal device has not directly switched to the LP-WUS monitoring mode yet, it may allow some sleeping when RTT timer is running. However, if the inactivity timer and the RTT timer are running simultaneously, due to the running of the inactivity timer, the terminal device 120 should monitor the PDCCH. If only RTT timer is running, the terminal device 120 may sleep for a while and not monitor the PDCCH.

In some exemplary embodiments, the retransmission timer is started upon expiry of the RTT timer. During the period of the retransmission timer, the terminal device 120 should monitor the PDCCH for the possible retransmission, and thus the terminal device 120 should monitor the PDCCH from the network device 110.

In some exemplary embodiments, when none of the inactivity timer, the RTT timer and the retransmission timer is running, the terminal device 120 switches to monitoring or receiving the LP-WUS without monitoring the PDCCH. In this example, when the timer is not running, it does not mean that the timer expires and may pause for a while.

In some exemplary embodiments, when at least one of the inactivity timer, the RTT timer and the retransmission timer expires, the terminal device 120 switches to monitoring or receiving the LP-WUS without monitoring the PDCCH.

In some exemplary embodiments, when all of the inactivity timer, the RTT timer and the retransmission timer have expired, the terminal device 120 switches to monitoring or receiving the LP-WUS without monitoring the PDCCH.

In still another option, the information comprises an indication received from the network device 110 for switching from monitoring the PDCCH to monitoring the LP-WUS. In this way, switching from PDCCH monitoring mode to LP-WUS monitoring mode may be based on explicit indication from the network device.

In some exemplary embodiments, the indication comprises a PDCCH skipping command transmitted from the network device. When the terminal device 120 receives this PDCCH skipping command, it will switch to LP-WUS monitoring mode directly, and the main receiver of the terminal device may be waked up again when receiving another new LP-WUS from the network device 110 in the future.

In some exemplary embodiments, the indication comprises a command other than a PDCCH skipping command. Differently from the PDCCH skipping command, this command for switching to LP-WUS monitoring mode may be defined while the PDCCH skipping is used to allow skipping PDCCH for a period but may still resume PDCCH monitoring without sending another new LP-WUS.

In a further still option, the terminal device 120 monitors the PDCCH periodically regardless of reception of the LP-WUS, wherein based on determining that the LP-WUS has not been received or decoded for a duration for periodically monitoring the PDCCH, the terminal device 120 switches from monitoring the LP-WUS to monitoring the PDCCH.

In some exemplary embodiments, periodic PDCCH monitoring without LP-WUS indication can be defined, e.g., similarly to onDuration occasion with DRX. That is to say, the terminal device 120 switches main radio or main receiver to monitor PDCCH periodically for certain time duration. This ensures that the NW has a fallback to schedule/serve the UE, when the terminal device 120 for some reason could not decode LP-WUS even though NW sent it. For example, if LP-WUS has not been received for certain time duration, the terminal device 120 starts the periodic PDCCH monitoring without LP-WUS indication.

FIG. 3 illustrates a flowchart of an example method 300 implemented at a terminal device in accordance with some other embodiments of the present disclosure. For the purpose of discussion, the method 500 will be described from the perspective of the terminal device 120 with reference to FIGS. 1A-2.

At block 310, the terminal device 120 obtains, from a network device, information related to the apparatus monitoring a physical downlink control channel (PDCCH) from the network device 110. At block 320, the terminal device 120 switches, based on the information, from monitoring the PDCCH to monitoring a low power wake-up signal (LP-WUS) from the network device 110.

In some exemplary embodiments, the information comprises a timer associated with the switching. In some exemplary embodiments, the timer is started upon reception of the LP-WUS. In some exemplary embodiments, the timer is started upon a first PDCCH occasion when the apparatus starts monitoring the PDCCH. In some exemplary embodiments, the timer is started upon first reception of a PDCCH after the apparatus starts monitoring the PDCCH.

In some exemplary embodiments, the timer is started when the monitoring of the PDCCH is started, in the event that a plurality of LP-WUS occasions wake up the apparatus to start monitoring the PDCCH in a PDCCH occasion. In some exemplary embodiments, the timer is restarted after at least one of a PDCCH reception, a PDSCH reception or an uplink transmission.

In some exemplary embodiments, the information comprises at least one of an inactivity timer, a round trip time (RTT) timer, and a retransmission timer. In some exemplary embodiments, the inactivity timer is started upon reception of the LP-WUS. In some exemplary embodiments, the inactivity timer is started upon a first PDCCH occasion after the apparatus starts monitoring the PDCCH. In some exemplary embodiments, the inactivity timer is started upon first reception of a PDCCH after the apparatus starts monitoring the PDCCH.

In some exemplary embodiments, the RTT timer is started upon transmission of a physical uplink shared channel (PUSCH) or a hybrid automatic repeat request (HARQ) for a downlink transmission. In some exemplary embodiments, the retransmission timer is started upon expiry of the RTT timer.

In some exemplary embodiments, when none of the inactivity timer, the RTT timer and the retransmission timer is running, the terminal device 120 switches to monitoring or receiving the LP-WUS without monitoring the PDCCH. In some exemplary embodiments, when at least one of the inactivity timer, the RTT timer and the retransmission timer expires, the terminal device 120 switches to monitoring or receiving the LP-WUS without monitoring the PDCCH. In some exemplary embodiments, when all of the inactivity timer, the RTT timer and the retransmission timer have expired, the terminal device 120 switches to monitoring or receiving the LP-WUS without monitoring the PDCCH.

In some exemplary embodiments, the information comprises an indication received from the network device for switching from monitoring the PDCCH to monitoring the LP-WUS. In some exemplary embodiments, the indication comprises a PDCCH skipping command. In some exemplary embodiments, the indication comprises a command other than a PDCCH skipping command.

In some exemplary embodiments, the terminal device 120 monitors the PDCCH periodically regardless of reception of the LP-WUS. In some exemplary embodiments, the monitoring the PDCCH periodically is by: based on determining that the LP-WUS has not been received for a duration for periodically monitoring the PDCCH, switch from monitoring the LP-WUS to monitoring the PDCCH.

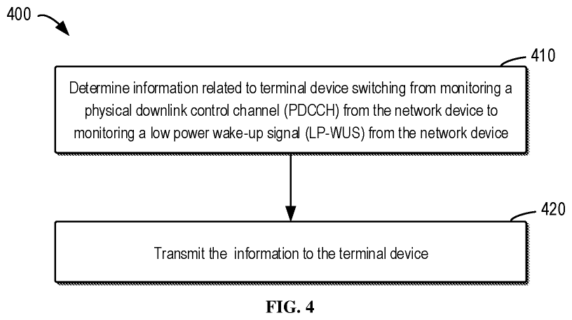

FIG. 4 illustrates another flowchart of an example method 400 implemented at a network device in accordance with some other embodiments of the present disclosure. For the purpose of discussion, the method 400 will be described from the perspective of the network device 110 with reference to FIGS. 1A-2.

At block 410, the network device 110 determines information related to a terminal device switching from monitoring a physical downlink control channel (PDCCH) from the apparatus to monitoring a low power wake-up signal (LP-WUS) from the apparatus. At block 420, the network device 110 transmits the information to the terminal device 120.

In some exemplary embodiments, the timer is started upon reception of the LP-WUS by the terminal device. In some exemplary embodiments, the timer is started upon a first PDCCH occasion when the terminal device starts monitoring the PDCCH. In some exemplary embodiments, the timer is started upon first reception of a PDCCH by the terminal device after the terminal device starts monitoring the PDCCH. In some exemplary embodiments, the timer is started when the monitoring of the PDCCH by the terminal device is started, in the event that a plurality of LP-WUS occasions wake up the terminal device to start monitoring the PDCCH in a PDCCH occasion. In some exemplary embodiments, the timer is restarted after at least one of a PDCCH reception, a PDSCH reception or an uplink transmission by the terminal device.

In some exemplary embodiments, the information comprises at least one of an inactivity timer, a round trip time (RTT) timer, and a retransmission timer. In some exemplary embodiments, the inactivity timer is started upon reception of the LP-WUS by the terminal device. In some exemplary embodiments, the inactivity timer is started upon a first PDCCH occasion after the terminal device starts monitoring the PDCCH. In some exemplary embodiments, the inactivity timer is started upon first reception of a PDCCH by the terminal device after the terminal device starts monitoring the PDCCH.

In some exemplary embodiments, the RTT timer is started upon transmission of physical uplink shared channel (PUSCH) or hybrid automatic repeat request (HARQ) feedback for downlink. In some exemplary embodiments, the retransmission timer is started upon expiry of the RTT timer.

In some exemplary embodiments, the information comprises an indication to indicate the terminal device to switch from monitoring the PDCCH to monitoring the LP-WUS. In some exemplary embodiments, the indication comprises a PDCCH skipping command. In some exemplary embodiments, the indication comprises a command other than a PDCCH skipping command. In some exemplary embodiments, the network device 110 transmits, to the terminal device, further information to configure the terminal device to monitor the PDCCH periodically regardless of reception of the LP-WUS.

In some embodiments, an apparatus (for example, the terminal device 120) capable of performing the method 300 may comprise means for performing the respective steps of the method 300. The means may be implemented in any suitable form. For example, the means may be implemented in a circuitry or software module.

In some embodiments, the apparatus comprises: means for obtaining, from a network device, information related to the apparatus monitoring a physical downlink control channel (PDCCH) from the network device; and means for switching, based on the information, from monitoring the PDCCH from the network device to monitoring a low power wake-up signal (LP-WUS) from the network device.

In some exemplary embodiments, the information comprises a timer associated with the switching. In some exemplary embodiments, the timer is started upon reception of the LP-WUS. In some exemplary embodiments, the timer is started upon a first PDCCH occasion when the apparatus starts monitoring the PDCCH. In some exemplary embodiments, the timer is started upon first reception of a PDCCH after the apparatus starts monitoring the PDCCH.

In some exemplary embodiments, the timer is started when the monitoring of the PDCCH is started, in the event that a plurality of LP-WUS occasions wake up the apparatus to start monitoring the PDCCH in a PDCCH occasion. In some exemplary embodiments, the timer is restarted after at least one of a PDCCH reception, a PDSCH reception or an uplink transmission.

In some exemplary embodiments, the information comprises at least one of an inactivity timer, a round trip time (RTT) timer, and a retransmission timer. In some exemplary embodiments, the inactivity timer is started upon reception of the LP-WUS. In some exemplary embodiments, the inactivity timer is started upon a first PDCCH occasion after the apparatus starts monitoring the PDCCH. In some exemplary embodiments, the inactivity timer is started upon first reception of a PDCCH after the apparatus starts monitoring the PDCCH.

In some exemplary embodiments, the RTT timer is started upon transmission of a physical uplink shared channel (PUSCH) or a hybrid automatic repeat request (HARQ) for a downlink transmission. In some exemplary embodiments, the retransmission timer is started upon expiry of the RTT timer.

In some exemplary embodiments, the apparatus further comprises: means for switching to monitoring or receiving the LP-WUS without monitoring the PDCCH, when none of the inactivity timer, the RTT timer and the retransmission timer is running. In some exemplary embodiments, the apparatus further comprises: means for switching to monitoring or receiving the LP-WUS without monitoring the PDCCH, when at least one of the inactivity timer, the RTT timer and the retransmission timer expires. In some exemplary embodiments, the apparatus further comprises: means for switching to monitoring or receiving the LP-WUS without monitoring the PDCCH, when all of the inactivity timer, the RTT timer and the retransmission timer have expired.

In some exemplary embodiments, the information comprises an indication received from the network device for switching from monitoring the PDCCH to monitoring the LP-WUS. In some exemplary embodiments, the indication comprises a PDCCH skipping command. In some exemplary embodiments, the indication comprises a command other than a PDCCH skipping command.

In some exemplary embodiments, the apparatus further comprises: means for monitoring the PDCCH periodically regardless of reception of the LP-WUS. In some exemplary embodiments, the means for monitoring the PDCCH periodically comprises:
means for switching from monitoring the LP-WUS to monitoring the PDCCH, based on determining that the LP-WUS has not been received for a duration for periodically monitoring the PDCCH.

In some embodiments, the apparatus further comprises means for performing other steps in some embodiments of the method 300. In some embodiments, the means comprises at least one processor and at least one memory including computer program code, the at least one memory and computer program code configured to, with the at least one processor, cause the performance of the apparatus.

In some embodiments, an apparatus (for example, the network device 110) capable of performing the method 400 may comprise means for performing the respective steps of the method 400. The means may be implemented in any suitable form. For example, the means may be implemented in a circuitry or software module.

In some embodiments, the apparatus comprises: means for determining information related to a terminal device switching from monitoring a physical downlink control channel (PDCCH) from the apparatus to monitoring a low power wake-up signal (LP-WUS) from the apparatus; and means for transmitting the information to the terminal device.

In some exemplary embodiments, the timer is started upon reception of the LP-WUS by the terminal device. In some exemplary embodiments, the timer is started upon a first PDCCH occasion when the terminal device starts monitoring the PDCCH. In some exemplary embodiments, the timer is started upon first reception of a PDCCH by the terminal device after the terminal device starts monitoring the PDCCH.

In some exemplary embodiments, the timer is started when the monitoring of the PDCCH by the terminal device is started, in the event that a plurality of LP-WUS occasions wake up the terminal device to start monitoring the PDCCH in a PDCCH occasion. In some exemplary embodiments, the timer is restarted after at least one of a PDCCH reception, a PDSCH reception or an uplink transmission by the terminal device.

In some exemplary embodiments, the information comprises at least one of an inactivity timer, a round trip time (RTT) timer, and a retransmission timer. In some exemplary embodiments, the inactivity timer is started upon reception of the LP-WUS by the terminal device. In some exemplary embodiments, the inactivity timer is started upon a first PDCCH occasion after the terminal device starts monitoring the PDCCH. In some exemplary embodiments, the inactivity timer is started upon first reception of a PDCCH by the terminal device after the terminal device starts monitoring the PDCCH.

In some exemplary embodiments, the RTT timer is started upon transmission of physical uplink shared channel (PUSCH) or hybrid automatic repeat request (HARQ) feedback for downlink. In some exemplary embodiments, the retransmission timer is started upon expiry of the RTT timer.

In some exemplary embodiments, the information comprises an indication to indicate the terminal device to switch from monitoring the PDCCH to monitoring the LP-WUS. In some exemplary embodiments, the indication comprises a PDCCH skipping command. In some exemplary embodiments, the indication comprises a command other than a PDCCH skipping command.

In some exemplary embodiments, the apparatus further comprises: means for transmitting, to the terminal device, further information to configure the terminal device to monitor the PDCCH periodically regardless of reception of the LP-WUS.

In some embodiments, the apparatus further comprises means for performing other steps in some embodiments of the method 400. In some embodiments, the means comprises at least one processor and at least one memory including computer program code, the at least one memory and computer program code configured to, with the at least one processor, cause the performance of the apparatus.

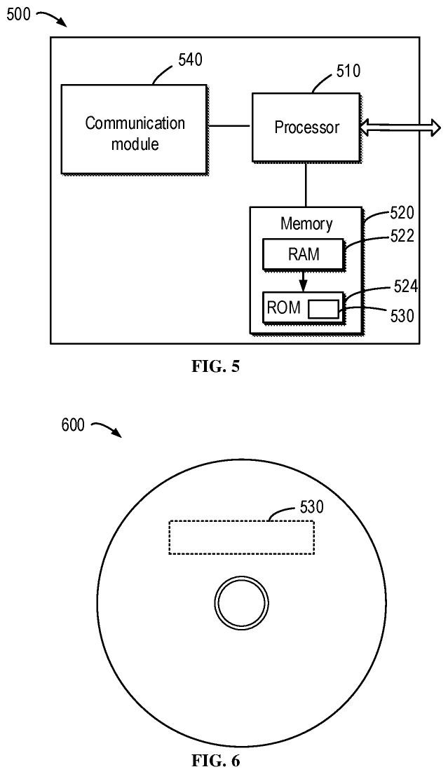

FIG. 5 illustrates a simplified block diagram of a device 500 that is suitable for implementing some exemplary embodiments of the present disclosure. The device 500 may be provided to implement a communication device, for example, the AP device 110 or the STA device 120 as shown in FIG. 1A. As shown, the device 500 includes one or more processors 510, one or more memories 520 coupled to the processor 510, and one or more communication modules 540 coupled to the processor 510.

The communication module 540 is for bidirectional communications. The communication module 540 has at least one antenna to facilitate communication. The communication interface may represent any interface that is necessary for communication with other network elements.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the ROM 524. The processor 510 may perform any suitable actions and processing by loading the program 530 into the RAM 522.

The embodiments of the present disclosure may be implemented by means of the program 530 so that the device 500 may perform any process of the disclosure as discussed with reference to FIG. 2. The embodiments of the present disclosure may also be implemented by hardware or by a combination of software and hardware.

In some exemplary embodiments, the program 530 may be tangibly contained in a computer-readable medium which may be included in the device 500 (such as in the memory 520) or other storage devices that are accessible by the device 500. The device 500 may load the program 530 from the computer-readable medium to the RAM 522 for execution. The computer-readable medium may include any types of tangible non-volatile storage, such as ROM, EPROM, a flash memory, a hard disk, CD, DVD, and the like.

FIG. 6 illustrates a block diagram of an example of a computer-readable medium 1000 in accordance with some exemplary embodiments of the present disclosure. The computer-readable medium 600 has the program 530 stored thereon. It is noted that although the computer-readable medium 600 is depicted in form of CD or DVD, the computer-readable medium 600 may be in any other form suitable for carry or hold the program 530.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer-readable storage medium. The computer program product includes computer-executable instructions, such as those included in program modules, being executed in a device on a target real or virtual processor, to carry out the method 300 or 400 as described above with reference to FIG. 3 or 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer-readable medium, and the like.

The computer-readable medium may be a computer-readable signal medium or a computer-readable storage medium. A computer-readable medium may include but not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

### List of Abbreviations

LP-WUS Low Power Wake-Up Signal
WuR Wake-up Receiver
eDRX extended Discontinuous Reception
IoT Internet of Things
PDCCH Physical Downlink Control CHannel
PDSCH Physical Downlink Shared Channel
HARQ Hybrid Automatic Repeat request
PUCCH Physical Uplink Shared Channel
RTT Round Trip Time

1.-44. (canceled)

45. An apparatus comprising:
at least one processor; and
at least one memory storing instructions that, when executed by the at least one processor, cause the apparatus at least to:
obtain, from a network device, information related to the apparatus monitoring a physical downlink control channel (PDCCH) from the network device; and
switch, based on the information, from monitoring the PDCCH to monitoring a low power wake-up signal (LP-WUS) from the network device.

46. The apparatus of claim 45, wherein the information comprises a timer associated with the switching.

47. The apparatus of claim 46, wherein the timer is started upon reception of the LP-WUS.

48. The apparatus of claim 46, wherein the timer is started upon a first PDCCH occasion when the apparatus starts monitoring the PDCCH.

49. The apparatus of claim 46, wherein the timer is started upon first reception of a PDCCH after the apparatus starts monitoring the PDCCH.

50. The apparatus of claim 46, wherein the timer is started when the monitoring of the PDCCH is started, in the event that a plurality of LP-WUS occasions wake up the apparatus to start monitoring the PDCCH in a PDCCH occasion.

51. The apparatus of claim 46, wherein the timer is restarted after at least one of a PDCCH reception, a PDSCH reception or an uplink transmission.

52. The apparatus of claim 45, wherein the information comprises at least one of an inactivity timer, a round trip time (RTT) timer, and a retransmission timer.

53. The apparatus of claim 52, wherein the inactivity timer is started upon reception of the LP-WUS.

54. The apparatus of claim 52, wherein the inactivity timer is started upon a first PDCCH occasion after the apparatus starts monitoring the PDCCH.

55. The apparatus of claim 52, wherein the inactivity timer is started upon first reception of a PDCCH after the apparatus starts monitoring the PDCCH.

56. The apparatus of claim 52, wherein the RTT timer is started upon transmission of a physical uplink shared channel (PUSCH) or a hybrid automatic repeat request (HARQ) for a downlink transmission.

57. The apparatus of claim 52, wherein the retransmission timer is started upon expiry of the RTT timer.

58. The apparatus of claim 52, wherein the apparatus is further caused to: when none of the inactivity timer, the RTT timer and the retransmission timer is running, switch to monitoring or receiving the LP-WUS without monitoring the PDCCH.

59. The apparatus of claim 52, wherein the apparatus is further caused to: when at least one of the inactivity timer, the RTT timer and the retransmission timer expires, switch to monitoring or receiving the LP-WUS without monitoring the PDCCH.

60. The apparatus of claim 52, wherein the apparatus is further caused to: when all of the inactivity timer, the RTT timer and the retransmission timer have expired, switch to monitoring or receiving the LP-WUS without monitoring the PDCCH.

61. The apparatus of claim 45, wherein the information comprises an indication received from the network device for switching from monitoring the PDCCH to monitoring the LP-WUS.

62. The apparatus of claim 45, wherein the apparatus is further caused to: monitor the PDCCH periodically regardless of reception of the LP-WUS.

63. An apparatus comprising:
at least one processor; and
at least one memory storing instructions that, when executed by the at least one processor, cause the apparatus at least to:
determine information related to a terminal device switching from monitoring a physical downlink control channel (PDCCH) from the apparatus to monitoring a low power wake-up signal (LP-WUS) from the apparatus; and
transmit the information to the terminal device.

64. An apparatus comprising:
means for obtaining, from a network device, information related to the apparatus monitoring a physical downlink control channel (PDCCH) from the network device; and
means for switching, based on the information, from monitoring the PDCCH to monitoring a low power wake-up signal (LP-WUS) from the network device.
